(19) United States
(12) Patent Application Publication
(10) Pub. No.: US 2020/0238614 A1
(43) Pub. Date: Jul. 30, 2020

(54) APPARATUS AND METHOD FOR HIGH-PRECISION THREE-DIMENSIONAL PRINTING USING SALT SOLUTION

(71) Applicant: Shanghai Ninth People's Hospital, Shanghai JiaoTong University School of Medicine, Shanghai (CN)

(72) Inventors: Zhiguang QIAO, Shanghai (CN); Xing ZHANG, Shanghai (CN); Yongqiang HAO, Shanghai (CN); Yu HAN, Shanghai (CN); Binbin SUN, Shanghai (CN); Chunbin LI, Shanghai (CN); Meifei LIAN, Shanghai (CN); Wenbo JIANG, Shanghai (CN); Kerong DAI, Shanghai (CN)

(73) Assignee: Shanghai Ninth People's Hospital, Shanghai JiaoTong University School of Medicine, Shanghai (CN)

(21) Appl. No.: 16/747,536

(22) Filed: Jan. 21, 2020

(30) Foreign Application Priority Data
Jan. 25, 2019 (CN) 2019100748617
Jan. 25, 2019 (CN) 2019201326321
Nov. 15, 2019 (CN) 201911118080X
Nov. 15, 2019 (CN) 2019219724944

(51) Int. Cl. B29C 64/232; B29C 64/245; B29C 64/209; B29C 64/112

(52) U.S. Cl. CPC B29C 64/232; B29C 64/245; B33Y 10/00; B29C 64/112; B29C 64/209

(57) ABSTRACT

The present disclosure relates to an apparatus and a method for high-precision three-dimensional printing using a salt solution. The apparatus includes a receiving platform system and a printing device. The receiving platform system includes a conductivity cell, a high-voltage electrostatic generation system, a printing platform, and a printing platform driver. The conductivity cell contains salt solution. The high-voltage electrostatic generating system is connected with the conductivity cell. The printing platform is disposed in the salt solution in the conductivity cell. The printing platform driver is connected with the printing platform to drive the printing platform to move along a Z′-axis perpendicular to a horizontal direction. The printing device prints a product on the printing platform. The apparatus is convenient to operate, and solves the problems of low resolution of biological 3D printing, limited product height, and difficulty in using multiple printing methods in combination.

### CROSS REFERENCE TO RELATED APPLICATIONS

The present disclosure is related to and claims the benefits of priority to Chinese Patent Application No. 2019100748617, entitled “Apparatus and Method for High-Precision Three-Dimensional Printing Using Salt Solution”, filed with SIPO on Jan. 25, 2019, Chinese Patent Application No. 2019201326321, entitled “Apparatus and Method for High-Precision Three-Dimensional Printing Using Salt Solution”, filed with SIPO on Jan. 25, 2019, Chinese Patent Application No. 201911118080X, entitled “High-Precision Integrated Apparatus Integrating Multiple 3D Bioprinting”, filed with SIPO on Nov. 15, 2019, and Chinese Patent Application No. 2019219724944, entitled “High-Precision Integrated Apparatus Integrating Multiple 3D Bioprinting”, filed with SIPO on Nov. 15, 2019, the contents of which are incorporated herein by reference in their entireties.

### BACKGROUND

### Field of Disclosure

The present disclosure relates to the technical field of three-dimensional printing, in particular, to an apparatus and method for high-precision three-dimensional printing using a salt solution.

### Description of Related Arts

In the 1990s, 3D bioprinting is mostly used to prepare some medical models and in vitro medical devices. Since the 21st century, scientists have begun using biocompatible materials to print and prepare human implants (such as prosthetic limb implants, artificial ear implants), tissue engineering scaffolds, and the like. In the last decade, more scientists and researchers have devoted themselves to fields such as 3D bioprinting to prepare 3D biological structures that are bionic in vitro. With the continuous development of 3D bioprinting processes, currently printing methods mainly include electrospinning, fused deposition, solution/melt near-field direct writing, droplet inkjet, and coaxial printing. These methods are based on extrusion or spray coating, and are widely used in tissue engineering, drug loading, medical dressings and other fields. However, there are still some problems to be solved in these devices. For example, most near-field direct writing devices on the market can only adjust the X and Y axes, and the Z-axis feed can only be set in advance and cannot be adjusted in real time. For electrostatic spinning, near-field direct writing, droplet inkjet, and other printing methods, the electric fields become unstable with the accumulation of materials, which limits the height of stacking and accuracy of printed products. Further, each printing method is limited by its own applicable materials and printing conditions. Therefore, different printing methods cannot be achieved by the same device. Therefore, how to combine various printing methods under a stable electric field and exert their respective advantages is the focus of research.

Traditional biological 3D printing devices based on electrospinning technology, including electrospinning, solution/melt near-field direct writing, droplet inkjet, etc., cannot adjust the Z-axis feed in real time. These devices can only set a constant value before printing. Moreover, these devices are all based on the two-dimensional layers stacking to achieve the preparation of three-dimensional structures, therefore cannot meet the requirements of high-precision three-dimensional solid printing.

In addition, due to the continuous accumulation of materials, these biological 3D printing devices cannot form a stable or constant electric field, which seriously affects the accuracy of the printed products and limits the accumulated height of materials. The method of manually adjusting the voltage according to the printing height relies on high-precision simulation and multiple experiments. It needs to be recalibrated for different materials and printing parameters, the operation is complicated, and the problems of printing accuracy and height cannot be effectively solved.

The tissue bionic demand is not only about the simulation of external contours and overall performance, but also the continuous pursuit of detailed bionics for various parts of the tissue and customized bionics for structural functions. Using only traditional biological 3D printing devices for alternate printing (such as using a robotic arm to move and print products between different devices) cannot meet the requirements of high-precision positioning, and it is time-consuming and labor-consuming. Therefore, a multi-printing integrated device operating under a stable electric field with cross-scale, cross-material, and cross-printing conditions needs to be developed.

### SUMMARY

The present disclosure provides an apparatus for high-precision three-dimensional printing using a salt solution. The apparatus includes a receiving platform system and a printing device. The receiving platform system includes a conductivity cell, a high-voltage electrostatic generation system, a printing platform, and a printing platform driver. The conductivity cell contains salt solution. The high-voltage electrostatic generating system is connected with the conductivity cell. The printing platform is disposed in the salt solution in the conductivity cell. The printing platform driver is connected with the printing platform to drive the printing platform to move along a Z′-axis perpendicular to a horizontal direction. The printing device prints a product on the printing platform. In the above apparatus of the present disclosure, the printing platform is disposed in the salt solution, the printing platform has the same potential as the salt solution to form a constant electric field. The biological printing material in the printing device is three-dimensionally printed on the printing platform located in the salt solution. In the printing process, the printing platform driver drives the printing platform to move along the Z′-axis, so that the top surface of the printed product on the printing platform is leveled with the top liquid surface of the salt solution in the conductivity cell, thus achieving preparing a sample with high accuracy and high height of stacking under a stable electric field. The apparatus is easy to operate and solves the problems of low resolution of biological three-dimensional printing and limited product height.

The present disclosure further provides a method for high-precision three-dimensional printing using a salt solution, including: adding a bioprinting material into a printing device; adding a salt solution with a preconfigured concentration into a conductivity cell; grounding the printing device or connecting the printing device to a positive high-voltage electrostatic generator in a high-voltage electrostatic generating system, connecting the conductivity cell to a negative high-voltage electrostatic generator in the high-voltage electrostatic generating system, turning on the high-voltage electrostatic generating system, and the printing device moving along an X-axis and a Y-axis in a horizontal direction and a Z-axis perpendicular to the horizontal direction and printing a product on a printing platform disposed in the salt solution; after the printing device prints a layer of product on the printing platform, driving the printing platform to move downward along a Z′-axis by a printing platform driver, so that a top surface of the product printed on the printing platform is leveled with a liquid surface of the salt solution, and repeating the printing process to finally obtain a high printed product.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates an apparatus for high-precision three-dimensional printing using a salt solution according to an embodiment of the present disclosure;

FIG. 2 illustrates an apparatus for high-precision three-dimensional printing using a salt solution according to another embodiment of the present disclosure;

FIG. 3 illustrates an internal structure of the printing nozzle according to an embodiment of the present disclosure;

FIG. 4A illustrates printing nozzles of an apparatus for high-precision three-dimensional printing using a salt solution according to an embodiment of the present disclosure;

FIG. 4B illustrates printing conditions corresponding to the printing nozzles of an apparatus for high-precision three-dimensional printing using a salt solution according to an embodiment of the present disclosure;

FIG. 5 illustrates a cross-scale fiber scaffold printed by an apparatus for high-precision three-dimensional printing using a salt solution according to an embodiment of the present disclosure;

FIG. 6 illustrates a composite biological sample printed by an apparatus for high-precision three-dimensional printing using a salt solution according to an embodiment of the present disclosure;

FIG. 7 illustrates a nanofiber printed by an apparatus for high-precision three-dimensional printing using a salt solution according to an embodiment of the present disclosure;

FIG. 8 illustrates a flowchart of a method for high-precision three-dimensional printing using a salt solution according to an embodiment of the present disclosure.

### REFERENCE NUMBERS

1 Printing chamber
2 Gantry moving platform
3 Z-axis driver
4 Printing nozzle
41 Electrostatic spinning nozzle
42 Fused Deposition nozzle
43 Solution/melt near-field direct writing nozzle
44 Droplet inkjet nozzle
45 Dual-cavity coaxial printing nozzle
46 Three-cavity coaxial printing nozzle
401 Printing nozzle housing
402 Heating jacket
403 Cartridge
5 Nozzle suction device
6 Laser rangefinder
7 Printing platform
8 Conductivity cell
9 Temperature control system
10 High-voltage electrostatic generating system
101 Negative high-voltage electrostatic generator
102 Positive high-voltage electrostatic generator
11 Control panel
12 Printing platform driver
13 PC control system
14 Air pressure control system
15 Receiving platform system
16 Printing device

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

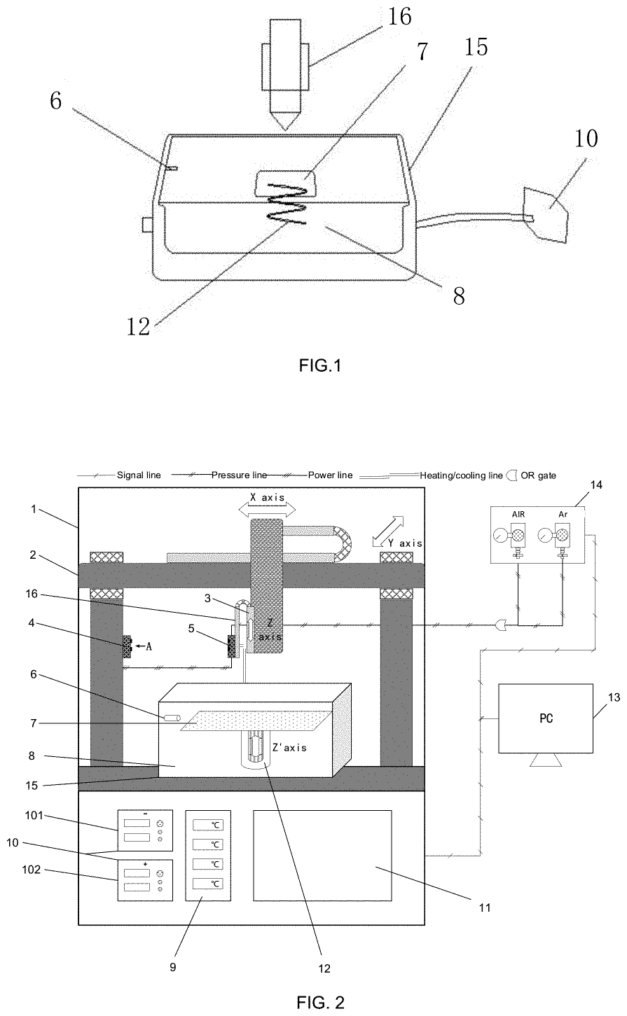

The present disclosure provides an apparatus for high-precision three-dimensional printing using a salt solution. Referring to FIGS. 1-2, the apparatus includes a receiving platform system 15 and a printing device 16. The receiving platform system 15 includes a conductivity cell 8, a high-voltage electrostatic generation system 10, a printing platform 7, and a printing platform driver 12. The conductivity cell 8 contains salt solution. The high-voltage electrostatic generating system 10 is connected with the conductivity cell 8. The printing platform 7 is placed in the salt solution in the conductivity cell 8. The printing platform driver 12 is connected with the printing platform 7 to drive the printing platform 7 to move along a Z′-axis perpendicular to a horizontal direction. The printing device 16 prints a product on the printing platform 7. When working, the high-voltage electrostatic generating system 10 supplies electricity to the conductivity cell 8. The printing device 16 containing the biological printing material prints a layer of product on the printing platform 7 immersed in the salt solution. Then the printing platform driver 12 controls the printing platform 7 to move downward along the Z′-axis perpendicular to the horizontal direction, so that the top surface of the printed product is leveled with the top liquid surface of the salt solution in the conductivity cell 8. Then a next layer of product is printed. The printing process is repeated until the complete product is printed. In the above apparatus of the present disclosure, the printing platform 7 is placed in the salt solution, the printing platform 7 has the same potential as the salt solution to form a constant electric field, thus preparing a sample with high accuracy and high height of stacking under a stable electric field. The apparatus is easy to operate and solves the problems of low resolution of biological three-dimensional printing and limited product height.

In some embodiments, the apparatus further includes a PC control system 13. The PC control system 13 is respectively connected with the high-voltage electrostatic generating system 10, the printing platform driver 12, and the printing device 16. The PC control system 13 controls the printing platform 7 to move along the Z′-axis through the printing platform driver 12, and controls the printing device 16 to print a product on the printing platform 7.

In some embodiments, the apparatus further includes a laser rangefinder 6 connected with the PC control system 13 to measure a height of a top surface of the product printed by the printing device 16 relative to a liquid surface of the salt solution in the conductivity cell 8. Preferably, the laser rangefinder 6 is disposed on the printing platform 7 to facilitate measurement. The printing platform driver 12 is disposed inside the printing platform 7. After receiving a height signal from the laser rangefinder 6, the PC control system 13 sends a feedback signal to the printing platform driver 12, and controls the printing platform 7 to move along the Z′-axis through the printing platform driver 12, so that the top surface of the printed product on the printing platform 7 is always leveled with the top liquid surface of the salt solution in the conductivity cell 8.

In some embodiments, the printing device 16 includes a printing nozzle 4, a Z-axis driver 3, and a nozzle suction device 5. The Z-axis driver 3 is connected with the PC control system 13. The nozzle suction device 5 is disposed on the Z-axis driver 3 and is adapted to the printing nozzle 4. The nozzle suction device 5 has an electrode interface on the surface connecting with the printing nozzle 4, the printing nozzle 4 is in contact with the nozzle suction device 5 through the electrode interface during the suction.

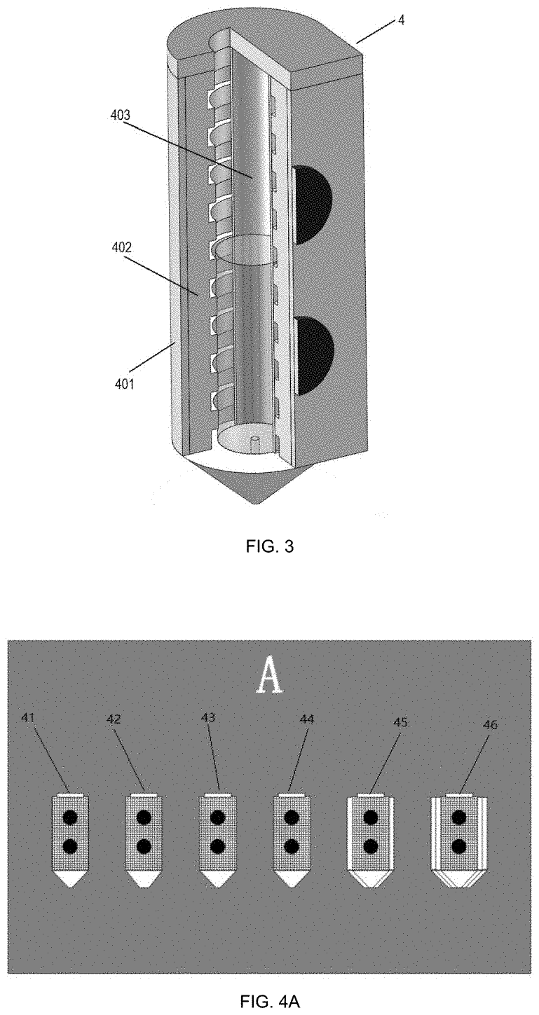

FIG. 3 illustrates an internal structure of the printing nozzle 4. The printing nozzle 4 includes a printing nozzle housing 401, a heating jacket 402, and a cartridge 403. The cartridge 403 is disposed in the heating jacket 402 and contains bioprinting material. The heating jacket 402 is disposed in the printing nozzle housing 401, for heating the bioprinting material in the cartridge 403. The printing nozzle housing 401 is made of metal. The heating jacket 402 may be a thermocouple type electric heating device, and the temperature of the heating jacket 402 ranges from room temperature to 500° C. The material of the cartridge 403 includes polytetrafluoroethylene or ceramic. The whole cartridge 403 is insulated and high temperature resistant. The volume of the cartridge 403 ranges from 0 to 50 mL.

As shown in FIG. 2, the apparatus further includes a printing chamber 1, which is an outer protective cover of the main body of the printing device 16. The printing chamber 1 can perform ultraviolet sterilization and control the overall temperature and humidity in itself. A gantry moving platform 2, the receiving platform system 15 and the printing device 16 are disposed inside the printing chamber 1. The gantry moving platform 2 is connected with the PC control system 13. The Z-axis driver 3 is movably mounted on the gantry moving platform 2. The printing nozzle 4 is disposed on the inside surface of the gantry moving platform 2 with a certain distance from the Z-axis driver 3. During printing, the PC control system 13 controls the nozzle suction device 5 to suck the printing nozzle 4 through the gantry moving platform 2 and the Z-axis driver 3, and further controls the printing nozzle 4 to move along the X-axis and the Y-axis in a horizontal direction and a Z-axis perpendicular to a horizontal direction. Specifically, the PC control system 13 can control the cross beam on the upper part of the gantry moving platform 2 to move along the X-axis and Y-axis in the horizontal direction, thereby driving the printing nozzle 4 sucked by the nozzle suction device 5 to move along the X-axis and Y-axis. Further, the PC control system 13 can control the Z-axis driver 3 to move along the Z-axis, thereby driving the printing nozzle 4 sucked by the suction device 5 to move along the Z-axis.

In some embodiments, the above-mentioned apparatus further includes a temperature control system 9 connected with the PC control system 13. The temperature control system 9 is used to control the heating temperature of the heating jacket 402 in the printing nozzle 4, thereby heating the bioprinting material in the cartridge 403. The heating temperature ranges from room temperature to 500° C., preferably from room temperature to 280° C.

In some embodiments, the apparatus further includes a control panel 11 connected with the PC control system 13, for displaying the heating temperature of the heating jacket 402, a voltage value of the high-voltage electrostatic generating system 10, and an ongoing printing process operation and printing status.

In some embodiments, the apparatus further includes an air pressure control system 14, which is respectively connected with the cartridge 403 and the PC control system 13, the air pressure control system 14 forms air pressure in the cartridge 403 by supplying air or inert gas, for extruding a molten or solution printing material. The air pressure control system 14 is preferably disposed outside the printing chamber 1 to facilitate the supply of air or inert gas. The air pressure ranges from 0 to 5 Mpa, preferably 0.2 Mpa.

In some embodiments, the high-voltage electrostatic generating system 10 includes a negative high-voltage electrostatic generator 101 and a positive high-voltage electrostatic generator 102. The negative high-voltage electrostatic generator 101 is connected with the conductive cell 8 through a wire. The working voltage of the negative high-voltage electrostatic generator 101 ranges from −50 to 0 kV, and a working voltage of the positive high-voltage electrostatic generator 102 ranges from 0 to 50 kV. When printing, the conductive cell 8 is connected with the negative high-voltage electrostatic generator 101, and the nozzle suction device 5 is grounded or connected with the positive high-voltage electrostatic generator 102 to form a potential difference and a stable electric field. The bioprinting material in the cartridge 403 is stretched and refined by the electric field force to form high-precision printed products.

In some embodiments, the nozzle suction device 5 is connected with the temperature control system 9, the positive high-voltage electrostatic generator 102 in the high-voltage electrostatic generating system 10, and the air pressure control system 14. The PC control system 13 can control the on-off between the nozzle suction device 5 and various control systems.

Specifically, the printing chamber 1, the gantry moving platform 2, the Z-axis driver 3, the printing nozzle 4, the nozzle suction device 5, the laser rangefinder 6, the printing platform 7, the conductivity cell 8, and the printing platform driver 12 constitute the main body of the three-dimensional printing apparatus.

In some embodiments, the PC control system 13 further includes an input interface and a display interface. The user can input the required three-dimensional digital model and printing condition parameters to the three-dimensional printing apparatus through the input interface and the display interface. Preferably, the PC control system 13 is disposed outside of the printing chamber 1 to facilitate user input of parameters. The PC control system 13 controls the operation of equipment through software, and automatically controls the movement of the platforms, the switching of the nozzles, and the adjustment and on-off of the control systems according to the three-dimensional digital model and printing condition parameters input by the user.

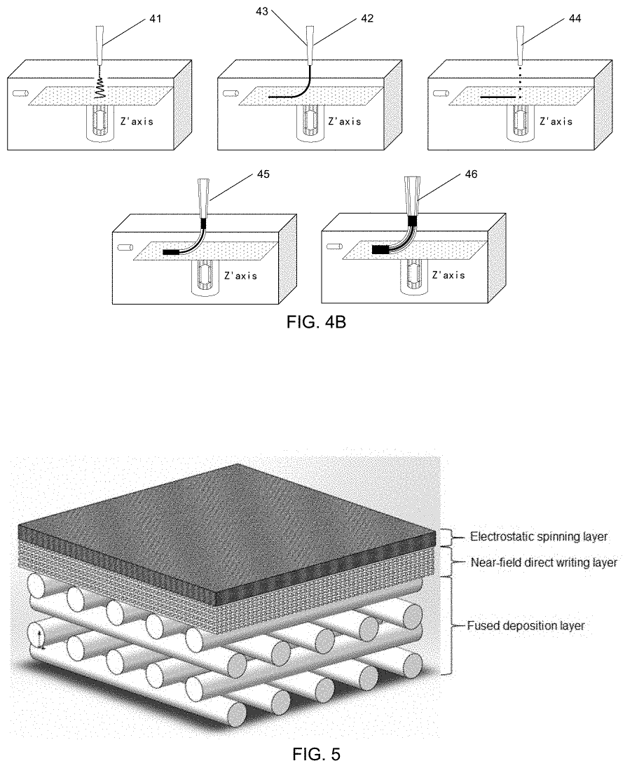

FIG. 4A illustrates printing nozzles 4. The printing nozzle 4 includes one or a combination of an electrostatic spinning nozzle 41, a fused deposition nozzle 42, a solution/melt near-field direct writing nozzle 43, a droplet inkjet nozzle 44, a dual-cavity coaxial printing nozzle 45, and a three-cavity coaxial printing nozzle 46. The printing nozzles 4 each contain their corresponding bioprinting materials. FIG. 4B illustrates printing conditions corresponding to different printing nozzles 4. The shapes and sizes of printing fibers extruded by different printing nozzles 4 are different. During printing, the nozzle suction device 5 is controlled by the PC control system 13 and adsorbs the corresponding printing nozzle 4 for different process operations, so as to print products with cross-scale, cross-material, and cross-printing conditions.

In some embodiments, the bioprinting material in the cartridge 403 includes a polymer material, such as polylactic acid (PLA), polycaprolactone (PCL), polyglycolide (PGA), polylactic acid-glycolic acid copolymer (PLGA), or L-polylactic acid (PLLA). During printing, polymer materials need to be heated and melted.

In some embodiments, the bioprinting material in the cartridge 403 includes a hydrogel material, such as sodium alginate hydrogel, methacrylated gelatin (GelMA), polyethylene glycol (diol) diacrylate (PEGDA), gelatin, or chitosan hydrogel.

In some embodiments, a component of the salt solution in the conductivity cell 8 includes sodium chloride, potassium chloride, calcium chloride, or the like. The electrical conductivity of the salt solution is adjusted by adjusting a concentration of the salt solution, and the electrical conductivity ranges from 1 to 500 mS/m. The conductivity cell 8 is preferably disposed on the gantry moving platform 2.

In some embodiments, the salt solution in the conductivity cell 8 may be a sodium chloride solution or calcium chloride solution with a concentration of 2 M (mol/L). When working, the negative high-voltage electrostatic generator 101 in the high-voltage electrostatic generating system 10 is adjusted to −5 kV, and a product is printed on the printing platform 7. After one layer of product is printed, the PC control system 13 controls the printing platform 7 to move downward along the Z′-axis through the printing platform driver 12. At the same time, a height of the top surface of the printed product relative to the top liquid surface of the salt solution is detected by the laser rangefinder 6, so that the top surface of the printed product is always kept leveled with the liquid surface of the salt solution in the conductivity cell 8. The printing process is repeated to finally obtain a printed product with a height exceeding 10 mm and a single fiber diameter of 10-50 μm.

FIG. 5 illustrates a cross-scale fiber scaffold printed by the above apparatus according to an embodiment of the present disclosure. Specifically, in the process of printing the cross-scale fiber scaffold, the polymer material polycaprolactone was added to the fused deposition nozzle 42, the solution/melt near-field direct writing nozzle 43, and the electrostatic spinning nozzle 41. The process operations, printing parameters and print models were set in the PC control system 13, the fused deposition printing process was set, and the temperature was adjusted to 80° C. through the temperature control system 9. In the melt near-field direct writing printing process, the temperature control system 9 adjusted the temperature to 70° C., the high-voltage electrostatic generating system 10 adjusted the positive pressure to 4 kV and the negative pressure to −2 kV, and the air pressure control system 14 adjusted the air pressure to 1 bar. In the electrospinning printing process, the temperature control system 9 adjusted the temperature to 80° C., the high-voltage electrostatic generating system 10 adjusted the positive pressure to 15 kV and the negative pressure to −1 kV, and the air pressure control system 14 adjusted the air pressure to 1 bar. Then during the printing process, the gantry moving platform 2 and the Z-axis driver 3 drive the printing nozzle 4 to move along the X, Y, and Z axes. The printing fibers are stacked on the printing platform 7. The printing platform 7 is driven by the printing platform driver 12 to move along the Z′-axis. A cross-scale fiber scaffold sample was finally printed.

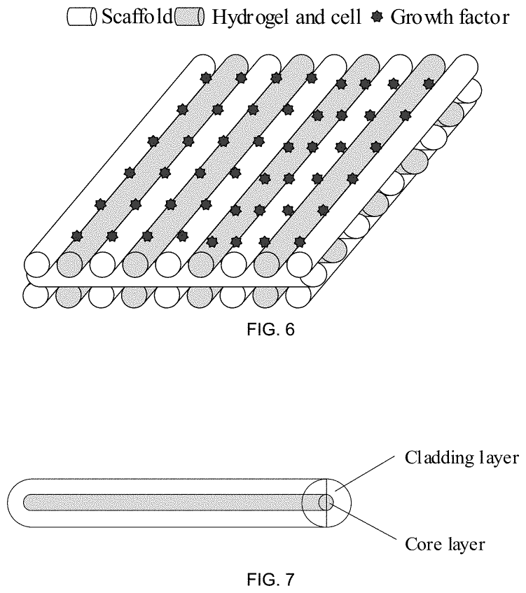

FIG. 6 illustrates a composite biological sample printed by the above apparatus according to an embodiment of the present disclosure. Specifically, in the process of printing the composite biological sample, firstly the polymer material polycaprolactone was added to the solution/melt near-field direct writing nozzle 43, the cell hydrogel material was added to the electrostatic spinning nozzle 41, biological materials mixed with growth factors was added to the droplet inkjet nozzle 44. Then the process operations, printing parameters and print models were set in the PC control system 13. The melt near-field direct writing printing process was set. The temperature control system 9 adjusted the temperature to 70° C. The high-voltage electrostatic generating system 10 adjusted the positive pressure to 4 kV and the negative pressure to −2 kV. The air pressure control system 14 adjusted the air pressure to 1 bar. In the cell hydrogel printing process, the temperature control system 9 was turned off, the high-voltage electrostatic generating system 10 adjusted the positive pressure to 2 kV and the negative pressure to −1 kV. The air pressure control system 14 adjusted the air pressure to 0.5 bar. In the droplet inkjet printing process, the temperature control system 9 was turned off, the high-voltage electrostatic generating system 10 adjusted the positive pressure to 2 kV and the negative pressure to −1 kV, and the air pressure control system 14 adjusted the air pressure to 0.5 bar. Then during the printing process, the gantry moving platform 2 and the Z-axis driver 3 drive the printing nozzle 4 to move along the X, Y, and Z axes. The printing fibers are stacked on the printing platform 7. The printing platform 7 is driven by the printing platform driver 12 to move along the Z′-axis. After stacking, a printed biological sample composed of fiber scaffolds, hydrogels, cells and growth factors was finally obtained.

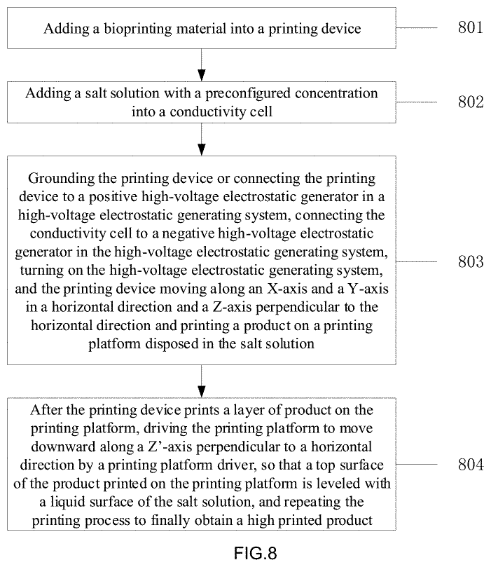

FIG. 7 illustrates a nanofiber printed by the above apparatus according to an embodiment of the present disclosure. Specifically, in the process of printing the nanofiber, an oil-phase solution obtained by dissolving a fat-soluble drug (referring to one or more of an anti-cancer drug, an anti-inflammatory drug, a fat-soluble antibiotic, and a fat-soluble vitamin) in a vegetable oil was added to the inner cavity of the dual-cavity coaxial printing nozzle 45. The aqueous solution obtained by dissolving the water-soluble polymer material added with emulsifier in water was added to the outer cavity of the dual-cavity coaxial printing nozzle 45. Then the process operations, printing parameters and print models were set in the PC control system 13. The electrostatic spinning printing process was set. The high-voltage electrostatic generating system 10 adjusted the positive pressure to 15 kV and the negative pressure to −1 kV, and the air pressure control system 14 adjusted the air pressure to 1 bar. Then during the printing process, the gantry moving platform 2 and the Z-axis driver 3 drive the printing nozzle 4 to move along the X, Y, and Z axes. The printing fibers are stacked on the printing platform 7. The printing platform 7 is driven by the printing platform driver 12 to move along the Z′-axis. A drug-loaded nanofiber with a skin-core structure is finally printed by stacking. The nano-fiber with the skin-core structure not only has high mechanical properties, but also realizes the loading of the fat-soluble drug.

FIG. 8 shows a flowchart of a method for high-precision three-dimensional printing using a salt solution. At block 801, a bioprinting material is added to the printing device. The bioprinting material includes a polymer material or a hydrogel material. When the bioprinting material is a polymer material, the method further includes heating and melting the material. When the bioprinting material is a cell hydrogel material, no heating is required.

At block 802, when printing, a salt solution with a preconfigured concentration is added to a conductivity cell. The salt solution may be a sodium chloride solution or a calcium chloride solution. At block 803, the printing device is grounded or connected with a positive high-voltage electrostatic generator in a high-voltage electrostatic generating system, the conductivity cell is connected with a negative high-voltage electrostatic generator in the high-voltage electrostatic generating system, the high-voltage electrostatic generating system is opened, and the printing device moves along an X-axis and a Y-axis in a horizontal direction and a Z-axis perpendicular to the horizontal direction, and prints a product on a printing platform located in the salt solution.

At block 804, after the printing device prints a layer of product on the printing platform, the printing platform driver drives the printing platform to move downward along a Z′-axis, so that a top surface of the product printed on the printing platform is leveled with a liquid surface of the salt solution, and the printing process is repeated to finally obtain a high printed product.

In some embodiments, the method further includes: measuring the height of the top surface of the printed product relative to the liquid surface of the salt solution in the conductivity cell by a laser rangefinder, and sending a signal of the height to a PC control system. The PC control system controls the printing platform to move downward along the Z′-axis according to the signal of the height, so that the top surface of the printed product on the printing platform is leveled with the liquid surface of the salt solution in the conductivity cell.

In some embodiments, a polymer material such as polycaprolactone was added to the printing device 16, the polymer material was heated and melted. When printing, a salt solution, such as a sodium chloride solution, with a concentration of 2 M (mol/L) was added into the conductivity cell 8. The printing device 16 was grounded or connected with the positive high-voltage electrostatic generator 102. The conductivity cell 8 was connected with the negative high-voltage electrostatic generator 101 in the high-voltage electrostatic generating system 10. The voltage was turned on and adjusted to −5 kV. The printing device 16 moved along the X-axis, Y-axis, and Z-axis to print a product on the printing platform 7. After one layer of product was printed, the PC control system 13 controlled the printing platform 7 to move downward along the Z′-axis through the printing platform driver 12, and controlled the liquid surface after the laser rangefinder 6 detected the liquid surface feedback, to ensure that the liquid surface of the salt solution was leveled with the top surface of the printed product. The process was repeated to finally obtain a printed product with a height of 2 cm and a single fiber diameter of 20 μm.

In some embodiments, a hydrogel material, such as a sodium alginate hydrogel, was added to the printing device 16. When printing, a salt solution, such as a calcium chloride solution, with a concentration of 2 M (mol/L) was added into the conductivity cell 8. The printing device 16 was grounded or connected with the positive high-voltage electrostatic generator 102. The conductivity cell 8 was connected with the negative high-voltage electrostatic generator 101 in the high-voltage electrostatic generating system 10. The voltage was opened and adjusted to −2 kV. The printing device 16 moved along the X-axis, Y-axis, and Z-axis to print a product on the printing platform 7. After a layer of product was printed, the PC control system 13 controlled the printing platform 7 to move downward along the Z′-axis through the printing platform driver 12, and controlled the liquid surface after the laser rangefinder 6 detected the liquid surface feedback, to ensure that the liquid surface of the salt solution was leveled with the top surface of the printed product. The process was repeated to finally obtain a printed product with a height of 4 cm and a single fiber diameter of 50 μm.

One skilled in the art will appreciate that, for this and other apparatuses and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

We claim:

1. An apparatus for high-precision three-dimensional printing using a salt solution, comprising:
a receiving platform system (15), comprising:
a conductivity cell (8), containing salt solution,
a high-voltage electrostatic generating system (10), connected with the conductivity cell (8),
a printing platform (7), disposed in the salt solution in the conductivity cell (8), and
a printing platform driver (12), connected with the printing platform (7), driving the printing platform (7) to move along a Z′-axis perpendicular to a horizontal direction; and
a printing device (16), disposed above the receiving platform system (15), and printing a product on the printing platform (7).

2. The apparatus for high-precision three-dimensional printing using a salt solution according to claim 1, further comprising a PC control system (13) respectively connected with the high-voltage electrostatic generating system (10), the printing platform driver (12), and the printing device (16).

3. The apparatus for high-precision three-dimensional printing using a salt solution according to claim 2, further comprising a laser rangefinder (6) connected with the PC control system (13), the laser rangefinder (6) measures a height of a top surface of the product printed by the printing device (16) relative to a liquid surface of the salt solution in the conductivity cell (8).

4. The apparatus for high-precision three-dimensional printing using a salt solution according to claim 2, wherein the printing device (16) comprises:
a printing nozzle (4);
a Z-axis driver (3), connected with the PC control system (13); and
a nozzle suction device (5), disposed on the Z-axis driver (3), the nozzle suction device (5) is adapted to the printing nozzle (4).

5. The apparatus for high-precision three-dimensional printing using a salt solution according to claim 4, wherein the printing nozzle (4) comprises one or a combination of an electrostatic spinning nozzle (41), a fused deposition nozzle (42), a solution/melt near-field direct writing nozzle (43), a droplet inkjet nozzle (44), a dual-cavity coaxial printing nozzle (45), and a three-cavity coaxial printing nozzle (46).

6. The apparatus for high-precision three-dimensional printing using a salt solution according to claim 4, wherein the printing nozzle (4) comprises:
a printing nozzle housing (401);
a heating jacket (402) disposed in the printing nozzle housing (401); and
a cartridge (403) disposed in the heating jacket (402) and containing a bioprinting material.

7. The apparatus for high-precision three-dimensional printing using a salt solution according to claim 6, wherein a material of the printing nozzle housing (401) comprises metal, and a material of the cartridge (403) comprises polytetrafluoroethylene or ceramic.

8. The apparatus for high-precision three-dimensional printing using a salt solution according to claim 6, wherein the bioprinting material comprises a polymer material or a hydrogel material.

9. The apparatus for high-precision three-dimensional printing using a salt solution according to claim 4, further comprising a gantry moving platform (2) connected with the PC control system (13).

10. The apparatus for high-precision three-dimensional printing using a salt solution according to claim 9, wherein
the Z-axis driver (3) is movably disposed on the gantry moving platform (2), the printing nozzle (4) is placed on the gantry moving platform (2), and the Z-axis driver (3) and the printing nozzle (4) are spaced by an interval from each other; and
when printing, the PC control system (13) controls the nozzle suction device (5) to suck the printing nozzle (4) through the gantry moving platform (2) and the Z-axis driver (3), and further controls the printing nozzle (4) to move along an X-axis and a Y-axis in a horizontal direction and a Z-axis perpendicular to the horizontal direction.

11. The apparatus for high-precision three-dimensional printing using a salt solution according to claim 9, further comprising a printing chamber (1) for containing the receiving platform system (15), the printing device (16), and the gantry moving platform (2); the printing chamber (1) is an outer protective cover of the receiving platform system (15), the printing device (16), and the gantry moving platform (2).

12. The apparatus for high-precision three-dimensional printing using a salt solution according to claim 6, further comprising a temperature control system (9) connected with the PC control system (13), the temperature control system (9) controls a heating temperature of the heating jacket (402) in the printing nozzle (4), thereby heating the bioprinting material in the cartridge (403), and the heating temperature ranges from room temperature to 500° C.

13. The apparatus for high-precision three-dimensional printing using a salt solution according to claim 12, further comprising a control panel (11) connected with the PC control system (13), for displaying the heating temperature of the heating jacket (402), a voltage value of the high-voltage electrostatic generating system (10), and an ongoing printing process operation and printing status.

14. The apparatus for high-precision three-dimensional printing using a salt solution according to claim 6, further comprising an air pressure control system (14), which is respectively connected with the cartridge (403) and the PC control system (13), the air pressure control system (14) forms air pressure in the cartridge (403) by supplying air or inert gas, and the air pressure ranges from 0 to 5 Mpa.

15. The apparatus for high-precision three-dimensional printing using a salt solution according to claim 1, wherein a component of the salt solution in the conductivity cell (8) comprises sodium chloride, potassium chloride, or calcium chlorine.

16. The apparatus for high-precision three-dimensional printing using a salt solution according to claim 15, wherein an electrical conductivity of the salt solution is adjusted by adjusting a concentration of the salt solution, and the electrical conductivity ranges from 1 to 500 mS/m.

17. The apparatus for high-precision three-dimensional printing using a salt solution according to claim 4, wherein the high-voltage electrostatic generating system (10) comprises a negative high-voltage electrostatic generator (101) connected with the conductivity cell (8).

18. The apparatus for high-precision three-dimensional printing using a salt solution according to claim 17, wherein the high-voltage electrostatic generation system (10) further comprises a positive high-voltage electrostatic generator (102), and the nozzle suction device (5) is connected with the positive high-voltage electrostatic generator (102) or grounded.

19. The apparatus for high-precision three-dimensional printing using a salt solution according to claim 18, wherein a working voltage of the negative high-voltage electrostatic generator (101) ranges from −50 to 0 kV, and a working voltage of the positive high-voltage electrostatic generator (102) ranges from 0 to 50 kV.

20. A method for high-precision three-dimensional printing using a salt solution, comprising:
adding a bioprinting material into a printing device;
adding a salt solution with a preconfigured concentration into a conductivity cell;
grounding the printing device or connecting the printing device to a positive high-voltage electrostatic generator in a high-voltage electrostatic generating system, connecting the conductivity cell to a negative high-voltage electrostatic generator in the high-voltage electrostatic generating system, turning on the high-voltage electrostatic generating system, and the printing device moving along an X-axis and a Y-axis in a horizontal direction and a Z-axis perpendicular to the horizontal direction and printing a product on a printing platform disposed in the salt solution;
after the printing device prints a layer of product on the printing platform, driving the printing platform to move downward along a Z′-axis perpendicular to a horizontal direction by a printing platform driver, so that a top surface of the product printed on the printing platform is leveled with a liquid surface of the salt solution, and repeating the printing process to finally obtain a high printed product.
